(19) United States
(12) Patent Application Publication
(10) Pub. No.: US 2003/0005171 A1
(43) Pub. Date: Jan. 2, 2003

(54) System for ordering software methods within an object to be used in a computer network testing scenario

(76) Inventor: Mark S. Schaeffer, San Ramon, CA (US)

Correspondence Address: William C. Milks, III, Russo & Hale LLP, 401 Florence Street, Palo Alto, CA, 94301, US

(21) Appl. No.: 09/896,038

(22) Filed: Jun. 29, 2001

(51) Int. Cl. G06F 9/44

(52) U.S. Cl. 709/315

(57) ABSTRACT

A system for facilitating the arrangement of software methods within an object built using an object oriented programming framework. The order of the methods is specified within a graphical user interface adapted for organizing the methods. Selecting an object in a list causes a dialog box to appear. Within the dialog box is an editable field that enables a unique sequential integer ascending from the number “1” to be entered corresponding to a method in the list. After an integer is assigned to a method, the object can then be selected and dragged and dropped into a window. Each method of the dropped object, to which an integer has been assigned, appears as an icon in the window in the order previously specified using the editable field. The methods are automatically arranged from the top of the window towards the bottom of the window in the order previously specified from lowest number to highest. The methods are executed in the specified order when the object is run, for example, in a scenario for testing and monitoring the response or performance of a computer network.

### FIELD OF THE INVENTION

The present invention relates to software tools and, more particularly, to software tools for testing and monitoring the response or performance of a computer network and components within that network and for maintaining uptime for the computer network such as a local area network (LAN) or wide area network (WAN), whether the network is an intranet or can connect to an extranet. As one example, the present invention relates to testing and monitoring a Web site comprised of computer network components accessible over the Internet or World Wide Web and, more particularly, to testing and monitoring and/or controlling computer network components at a Web site to promote e-business uptime. Specifically, one embodiment of the present invention provides a system to order software methods comprising an object to be included in a testing or monitoring scenario to enable the scenario to be quickly and easily configured and reconfigured by a relatively unsophisticated user. More specifically, a preferred embodiment of the present invention provides a system for facilitating configuration of scenarios for testing and monitoring the response or performance of a computer network and components within that network such as at a Web site.

### BACKGROUND OF THE INVENTION

In recent years, the number of computer networks has increased at an astronomical rate. LANs have become prevalent in businesses, and LANs are more and more frequently being installed in homes. Enterprises are typically connected through WANs. Thus, so-called “intranet” computer networks are commonplace.

These computer networks can also connect to so-called “extranet” computer networks, as well as to the Internet or World Wide Web. Often, connection to the extranet is secured by a so-called “firewall.” Enterprises typically have a Web site that can be accessed for information or to conduct e-commerce, for example.

Computer networks comprise various components, for example, various workstations and a file server that provides access to shared data and applications, as well as an operating system platform such as UNIX, Solaris, Linux, Windows NT, Windows 2000, or other operating system. A Web application can be run on a server to provide a Web site based on a standard Internet protocol such as TCP/IP. The load handled by the computer network components varies. The computer network must be able to handle diverse demands, or the network will experience processing delays and may even crash. It is important for an enterprise to know whether or not the proprietary portion of the computer network can handle the expected load and be able to control various components to avoid a crash. It is also important for the enterprise to be able to ascertain when additional components and/or load balancing is needed to increase the data handling capacity of the proprietary computer network. These measures can be adopted to optimize the so-called “uptime” of the enterprise's computer network. This is particularly important where downtime can adversely affect the revenues of the business.

Consequently, in order to maximize e-business, enterprises need to solve the computer network uptime problem. Solving the uptime problem means providing owners of computer networks the ability to load-test, simulate failure, monitor, access, and, preferably, control all components throughout the computer network during their lifecycle without regard to interface technology, protocols, or location. Various approaches are known for testing and monitoring computer networks.

One such approach is provided by Five Nine Solutions, Inc. located in Reno, Nev., which is a leading provider of distributed testing and monitoring tools for high-availability, enterprise-wide, and Internet-based or Web-based application computer networks. That company supplies a product called “RemoteCog” that includes tools needed for e-business to deal with the uptime problem. The RemoteCog product comprises a “control center” that integrates computer network testing, monitoring, access, control, and failure simulation for e-business, e-commerce, and wireless Internet systems. The RemoteCog product including the control center is a cost-effective, flexible, and highly extensible testing and monitoring solution that allows business-to-business enterprise and dot corn customers to deploy high-performance and reliable e-business systems.

Five Nine Solutions' RemoteCog product identifies bottlenecks and enables adjustments to a computer network to achieve maximum e-business uptime quickly. The RemoteCog product provides all that is needed by an enterprise for e-business uptime assurance, because the enterprise can: a) load-test, simulate failure, monitor, and access and control all computer network components throughout the network lifecycle; b) use the same set of testing and monitoring scenarios throughout the lifecycle; c) test network performance while the enterprise can still avert potential problems; d) rapidly create and deploy tests with no coding; e) easily integrate third-party products, as well as existing scripts and programs, into the RemoteCog product; f) integrate testing and monitoring for API, Web, ODBC, SQL, and character based interfaces; and g) build custom objects for enhanced tests, or for controlling and monitoring other products or components.

Because the framework of the RemoteCog product is object oriented, new objects can be rapidly built to address emerging technologies, protocols, and, ultimately, new customer needs. This capability is used to build new objects that typically comprise more than one method.

Unfortunately, while objects can be conveniently built within the object oriented programming framework of the RemoteCog product, once an object is built, modification of the order of the methods that comprise that object requires dragging and dropping the individual methods in the desired order to reconfigure the object. This procedure is prone to error and can be time-consuming. This results in various inefficiencies and attendant costs associated with the time requirement to re-arrange methods comprising an object used for a testing or monitoring scenario. As a consequence, difficulty and delay can be experienced in dealing with the uptime problem.

It would therefore be desirable to facilitate the arrangement of methods within an object built using an object oriented programming framework. It would also be desirable to provide a process to effectively re-order available methods within an object in an easy, quick, and virtually foolproof manner. Additionally, it would be desirable to enable a user to access a computer network testing or monitoring object and order the methods within that object in an efficient manner so as to avoid delay in addressing the uptime problem.

### SUMMARY OF THE INVENTION

The present invention addresses the aforementioned problems by providing a method and apparatus for facilitating the arrangement or organization of methods within an object built using an object oriented programming framework. One embodiment of the present invention provides a process and software tool to effectively re-order available methods within an object in an easy, quick, and virtually foolproof manner, for example, to enable a user to access a computer network testing or monitoring object and order the methods within that object in an efficient manner so as to avoid delay in addressing the uptime problem.

One embodiment of the object configuration tool in accordance with the present invention provides a framework for aggregating methods that comprise an object in the object library or that are coded by a developer. The object configuration tool enables the developer or a relatively unsophisticated user to specify the order in which the methods will be executed when a testing or monitoring scenario is created and launched. Preferably, the object configuration tool provides a graphical user interface to facilitate ordering the methods by the developer or user.

In one embodiment in accordance with the present invention, a method and software tool provide an intelligent mechanism whereby software specification steps can self organize within a specification scenario, thereby permitting automation of the specification process. One implementation of the software tool is embedded within a computer network testing and monitoring tool such as the RemoteCog product to provide an automatic sequencing mechanism for self organizing of software modules within a graphical user interface used to specify such software modules.

For example, within the RemoteCog control center, an object workbench is started by opening a “umethods.c” file. This causes a window to appear, which contains a text list of the individual methods contained in an object. Each individual text item in the list can then be selected with a pointing device such as a mouse. Double clicking the left mouse button with the mouse pointer on the selected item in the list causes a dialog box to appear. Preferably, within the dialog box is an editable field called “Autopaste Order”, for example. The developer or user can enter a unique sequential integer ascending from the number “1” in this field. This list item selection process is preferably repeated for each method in the list.

From an object browser included in the control center, an entire object can then be selected by the mouse and dragged and dropped into a scenario wizard window. Each individual method, to which a unique sequential integer has been assigned, included in the dropped object will then appear as an icon in a scenario wizard window. The “Autopaste Order” previously entered using the object workbench will thus control the order of appearance of those method icons in the scenario wizard window. The method icons will be automatically arranged from the top of the window towards the bottom of the window in the order previously specified using the object workbench from the lowest number to the highest.

The object configuration tool in accordance with the present invention integrates seamlessly within an object oriented programming framework that is modular and highly scalable. Thus, the object configuration tool enables customized configuration and implementation of objects through ordering of selected methods comprising those objects.

The object configuration tool in accordance with the present invention effectively aggregates methods within an object created by a developer and provides the order in which a selected collection of methods, and preferably the entire collection of methods, is carried out. No known object oriented system enables modularized methods aggregated within an object to be ordered and/or re-ordered by the user for configuring the object using a dialog box. The object configuration tool of the present invention thus enables objects to be easily and quickly configured so that testing and monitoring scenarios incorporating those objects can be created and/or modified by the user for more rapid deployment as mission critical testing and monitoring scenarios for computer networks, for example, to address the uptime problem.

### BRIEF DESCRIPTION OF THE DRAWINGS

Various embodiments of the object configuration tool in accordance with the present invention will now be described in detail with reference to the accompanying drawings.

FIG. 1 illustrates a schematic diagram of the object configuration tool in accordance with the present invention incorporated into a tool for specifying a testing and monitoring scenario for a computer network, for example.

FIG. 2 shows a screen that illustrates opening a source code file “umethods.c” associated with an object to invoke an object workbench.

FIG. 3 shows a screen that illustrates that for specified methods within an object identified in FIG. 2, the order and parameters can be specified using the object workbench.

FIG. 4 includes a Microsoft C++ screen typically used to build an object and illustrates once the methods are defined using the object workbench, function prototypes are created and are compiled into the object.

FIG. 5 shows a screen that illustrates a scenario wizard for configuring a testing and monitoring scenario using the available objects and the associated methods that an object browser displays with the default ordering being shown.

FIG. 6 shows a screen that illustrates that the scenario wizard automatically loads the scenario with methods of the object in the sequence specified by the developer or user using the object configuration tool of the present invention.

FIG. 7 shows a screen that illustrates executing a configured testing scenario.

### DETAILED DESCRIPTION OF THE PREFERRED EMBODIMENTS

According to the present invention and referring now to the figures, wherein like reference numerals identify like elements of the various embodiments of the invention, one can effectively specify the order and thus arrange methods within an object preferably created within an object oriented programming framework. Additionally, one can access that object and re-order the incorporated methods to thus modify the object. One can also easily access the object and underlying methods through a graphical user interface.

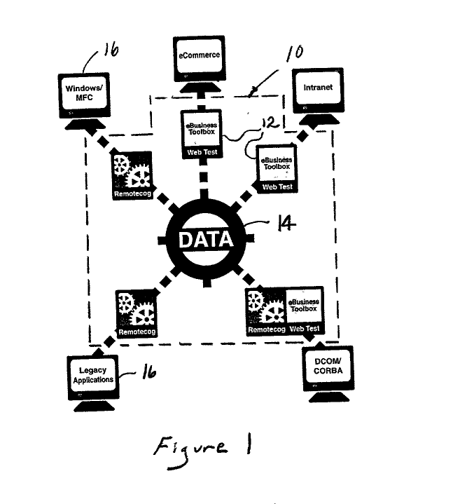

Although the principles of the present invention can be applied to any object oriented programming environment, an embodiment of the object configuration tool in accordance with the present invention will be described in conjunction with a testing and monitoring software tool for computer networks by way of example and not by way of limitation, in order to promote a better understanding of the invention. Accordingly, as shown in FIG. 1, a testing and monitoring tool 10 for a computer network is provided to solve the uptime problem. For example, the testing and monitoring tool 10 enables enterprises to reach maximum e-business uptime quickly. By way of example, the testing and monitoring tool 10 may comprise the aforementioned RemoteCog product.

Accordingly, the testing and monitoring tool 10 preferably comprises one or more “toolboxes” 12, third-party products, or programs/scripts that the enterprise has already developed. These objects are all incorporated into the framework of the testing and monitoring tool 10. Because the testing and monitoring tool 10 can drive any or all toolboxes 12 simultaneously, constructing sophisticated testing, monitoring, and task automation scenarios is fast, easy, and requires no coding expertise. The framework for the testing and monitoring tool 10 provides distributed advanced protocol and technology independent capabilities that enable publishing, controlling, and running objects anywhere on the computer network or Internet.

The testing and monitoring tool 10 enables a developer or even an unsophisticated user to rapidly design testing and monitoring scenarios without programming. The testing and monitoring tool 10 comprises a control center that enables a developer or user to manage testing and monitoring scenarios and their execution. In addition, scenario information and results are preferably centrally stored in a repository 14 for maximum flexibility. The repository 14 can reside in any Oracle, Ingres II, SQL Server, or other ODBC compliant datastore.

Using the control center, the developer or user can plan, organize, and control scenarios composed of methods provided by objects. These scenarios can monitor and load-test computer networks in addition to automating tasks such as network and database maintenance.

To identify and quantify performance issues that may exist in the computer network under consideration, the developer or user of a testing and monitoring scenario begins by identifying components 16 that he or she wants to verify. These components 16 may consist of sections of an application such as shell scripts, reports, database and API calls. In addition, using the control center, the developer can also design workload scenarios that will allow the developer to quickly verify whether a potential hardware solution will be sufficient.

The developer or user of a testing and monitoring scenario designs the workload scenario using an “object browser” and “scenario wizard” to visually assemble the methods provided by the various objects that can be selected using the object browser. The objects that are accessed via the object browser include those provided with the control center, by third parties, or custom objects constructed with an “object workbench”.

The object workbench enables the developer to quickly develop custom objects. Toolboxes are built using the object workbench, so custom objects behave as any toolbox 12. Building customized objects enables non-programmers to construct sophisticated scenarios without coding. Once an object is built, the object can be re-used. VARS and SIs can quickly build objects that provide added value to their customers.

The control center preferably includes the following toolboxes 12. As shown in FIG. 1, one toolbox is an “eBusiness toolbox” 12 that enables rapid testing of Web sites without coding. In just three quick steps, the developer or user can run thousands of virtual Web users against a Web site. The eBusiness toolbox 12 also captures and plays back wireless browser traffic. The eBusiness toolbox 12 is extensible for complex Web site testing.

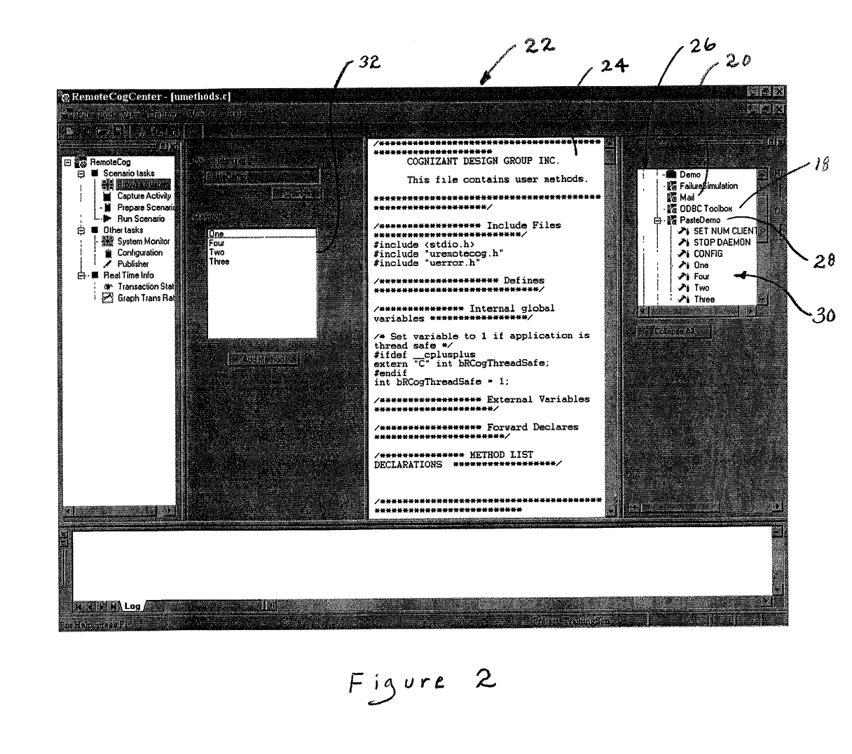

Additionally, as shown in FIG. 2, the control center includes as a toolbox an “ODBC toolbox” 18 to construct scenarios that issue SQL against an ODBC compliant DBMS for database access. Also, as shown in FIG. 2, a “Mail” toolbox 20 is included in the control center to provide the ability to stress and monitor SMTP and POP3 e-mail servers. Message size and e-mail addresses can be graphically randomized to enable sophisticated testing. Used in conjunction with the monitoring capabilities of the testing and monitoring tool 10, the developer or user can detect e-mail problems early.

Another toolbox is an “OS toolbox” to construct scenarios that use UNIX or Windows command line utilities. The OS toolbox also contains a “PING” (Preventative InterNet Guard) object that enables the developer to monitor any machine and take action on failure, including paging or notifying a system administrator for the computer network.

Further, the control center preferably includes an “FTP toolbox” designed to enable fast testing of FTP servers. The developer or user can specify message size, upload, and download information. As with other toolboxes 12, FTP test results are automatically published to the repository 14 shown in FIG. 1. By creating scenarios that test Web sites and use the FTP toolbox, the developer or user can test all facets of the user experience at a Web site, including FTP downloads, in one easy test.

An embodiment of the object configuration tool in accordance with the present invention will now be described. In general, the object configuration tool in accordance with one embodiment of the present invention employs a graphical user interface. The user and interface features will now be described in detail.

Referring again to FIG. 2, opening a source code file “umethods.c” associated with a toolbox or object within the control center invokes an object workbench 22. The lines of code are displayed in the user interface so that a developer can edit, add, or delete the corresponding code for the methods, that appears in the scroll box 24 located in the center of FIG. 2. Using the object workbench 22, a developer or user can define the methods and parameters for an object. Additionally, the object configuration tool of the present invention enables the developer or user to manipulate methods by selecting the order of methods that define the object.

For example, various objects are listed in an “Object Browser” scroll box 26 that appears at the right hand side of FIG. 2. Each object is identified by an icon, for example, a set of interengaged cogs or gears. The developer or user can position the pointer of a pointing device such as a mouse on the cog icon and double click the left mouse button to list methods that comprise the object. For example, clicking on the cog icon preceding the “PasteDemo” object 28 reveals the list of constituent methods 30 for that object, including system methods consisting of methods styled in all upper case letters, for example, “CONFIG”, and user methods consisting of methods styled in mixed case letters, for example, “One”, “Four”, “Two”, and “Three”, each of which is preceded by a method icon such as a hammer and screwdriver. The method icon identifies the listed item as a method. The order in which the methods are listed in the “Object Browser” scroll box 26 is the default order established by the developer of the object.

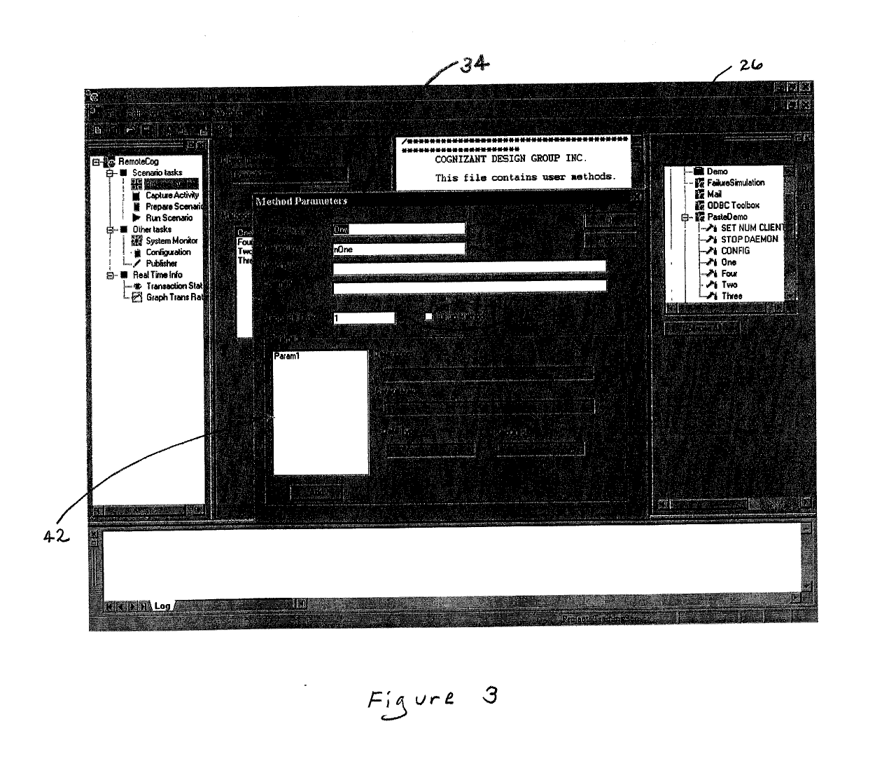

When the developer or user desires to modify the default ordering of the methods 30 shown in the “Object Browser” scroll box 26 that appears on the right hand side of FIG. 2, he or she positions the mouse pointer on the method displayed in the “Methods” box 32 and double clicks the left mouse button. Double clicking on one of the listed methods shown in the “Methods” box 32 pulls up a “Method Parameters” dialog box 34, as shown in FIG. 3.

The “Method Parameters” dialog box 34 displays the selected “Method Name” and corresponding “‘C’ function name” in respective fields 36 and 38, as shown in FIG. 3. For each method within the object, the order can be specified using an “Autopaste Order” field 40. For example, the developer or user can specify that the method “One” be executed first in order among the user methods by entering the integer “1” in the “Autopaste Order” field 40, as shown in FIG. 3. Similarly, using the “Method Parameters” dialog box 34, the developer or user can modify the order shown in the “Object Browser” scroll box 26 from the default execution order so that method “Two” is executed second, rather than third; method “Three” is executed third, rather than fourth; and method “Four” is executed fourth, rather than second, when the object is configured in a test scenario and launched. That is, the original default order of methods “One”, “Four”, “Two”, and “Three” can be rearranged as “One”, “Two”, “Three”, and “Four” by selecting each method in the “Methods” box 32 shown in FIG. 2 and specifying its position in the sequence using the “Autopaste Order” field 40 shown in FIG. 3 to assign an integer number to the method (i.e., “1”, “2”, “3”, “4”). Additionally, the developer or user can specify various parameters imported to the method using a “Parameters” dialog box 42.

In a modified embodiment, an autopaste specification may not be provided for one or more methods comprising an object, while an autopaste specification is specified for other methods comprising the object. Consequently, in the case in which an autopaste specification is not associated with a method that appears in the “Methods” box 32 which is double-clicked, the “Autopaste Order” field 40 is blank, that is, does not display a place for the method in the sequence. Preferably, the developer or user can nevertheless override by entering an integer in the “Autopaste Order” field 40 to specify the sequential position of the method within the object and cause an autopaste specification to be created for the method so that the method is included in the object in the specified order in the sequence when the object is selected for inclusion in a testing or monitoring scenario, as will be described later.

The object comprising the methods has a structured ordering that is actually embedded in the C-type file. The object configuration tool of the present invention has the ability to change the ordering through a dialog box to facilitate configuration of objects by less sophisticated users.

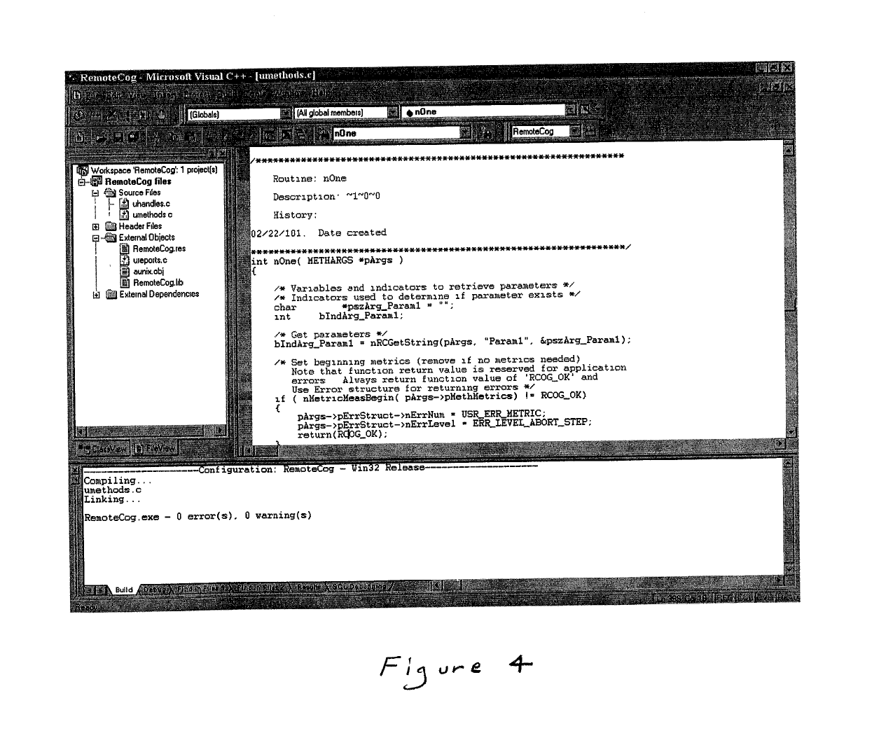

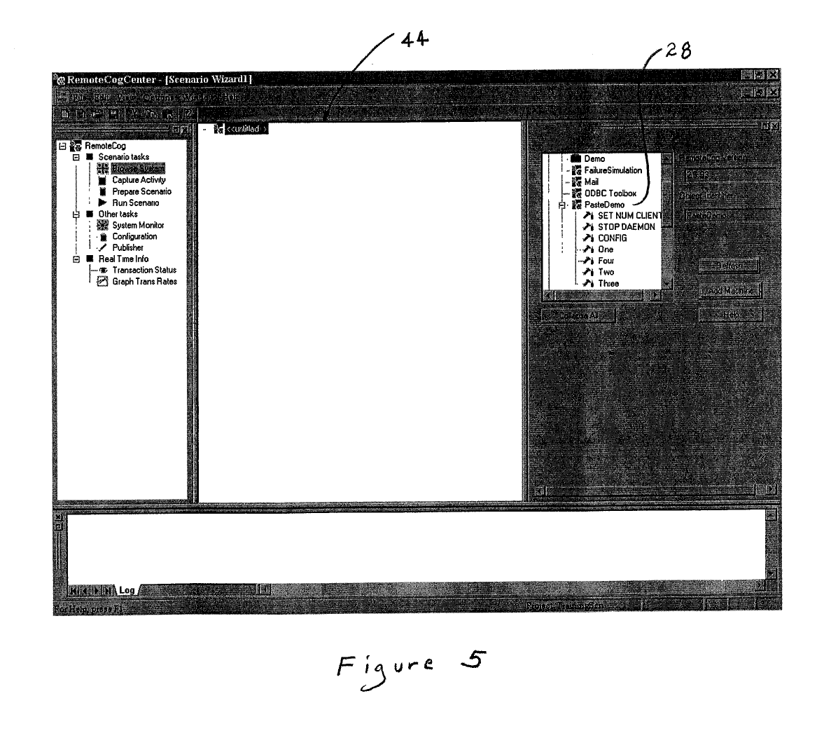

Once the order of the methods is specified within the object workbench 22, function prototypes are created and need to be compiled into the object, as shown at the bottom of FIG. 4. After compiling, the “Object Browser” scroll box 26 continues to display the available objects and the associated methods according to the default sequence, as shown in FIG. 5. The autopaste order affects the order in which the methods are pasted by the scenario wizard. The default order in which the methods appear in the object browser does not change. The operation of the object configuration tool is then as follows.

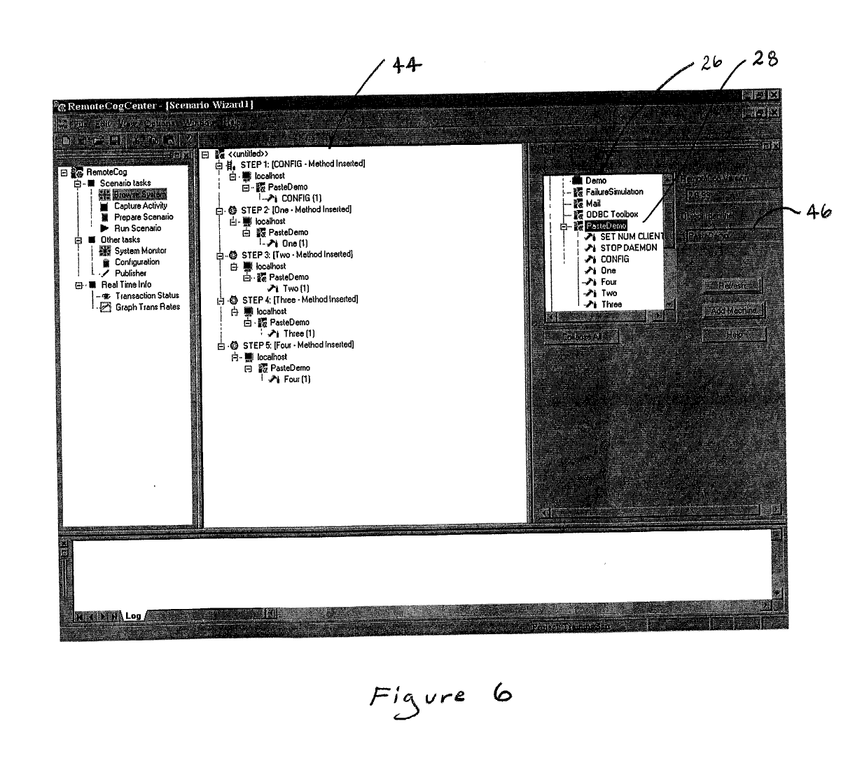

In order to take advantage of the functionality of the object configuration tool in accordance with the preferred embodiment of the present invention, the developer or user positions the mouse pointer on a selected object, for example, the “PasteDemo” object 28, and clicks and drags that object into a “Scenario Wizard” window 44 that appears in the center of FIG. 5. The object (i.e., “PasteDemo”) is highlighted in the “Object Browser” scroll box 26 and appears in an “Object Identifier” radio box 46 at the right hand side of FIG. 6. The scenario wizard automatically loads the scenario with the methods in the sequence predefined by the developer or user, as described above in conjunction with FIGS. 2 and 3. As shown in FIG. 6, the order of the methods, namely, “One”, “Two”, “Three”, “Four”, that appears in the “Scenario Wizard” window 44, is the modified order that was specified by the developer or user, as opposed to the original default order displayed in the “Object Browser” scroll box 26.

A system method “CONFIG” also preferably has an autopaste specification. The “CONFIG” method is assigned an unalterable default order number zero (“0”) and is thus always the first method to be executed. User methods, for example, methods assigned an order number “1” and greater, appear afterwards.

As shown in FIG. 6, the system method “CONFIG” is positioned as a “setup” step first in order. Preferably, a “setup” step is indicated by a ladder and paint can icon preceding the “CONFIG” method. The user methods “One”, “Two”, “Three”, and “Four” are sequentially positioned as “test” steps following the “CONFIG” method. Preferably, “test” steps are indicated by a stop watch icon preceding each method.

In summary, one embodiment of the present invention provides an object configuration tool integrated into an object oriented programming framework. The object configuration tool can be used by developers and users, who have a general understanding of computer networks hardware and software, to readily configure objects.

The object configuration tool aids construction of executable objects for tests. The developer or user designates what is supposed to happen in what sequence specifying the order of methods within an object, and the object configuration tool enables the order to be modified and automatically changes the structured ordering in the underlying code to effect the modified order of the methods.

The order of the methods contained in an object can be modified in the object workbench 22 using the “Autopaste Order” field 40 in the “Method Parameters” dialog box 34. When a developer or user wants to use all of the methods of an object in a scenario for a test, rather than clicking and dragging each method over or having to remember which one to execute in what order, he or she can simply click and drag the entire object into the “Scenario Wizard” window 44 to automatically populate the scenario in the desired order. That is, all the developer or user needs to do is click on and drag the object over, and the test scenario will be populated with the methods comprising the object in the order in which the methods are to be performed when the object is dropped. This provides a shortcut for the test scenario writer. So it is easier for the developer or user to specify the order in which the methods are to be performed by simply designating the order using a dialog box and the user to use that order to create a test scenario. If the developer or user wants to re-order the methods, the interaction is at the dialog box level, and the object configuration tool in accordance with the preferred embodiment of the present invention automatically effects the structured ordering of methods in accordance with values entered in the “Autopaste Order” field 40.

The object configuration tool in accordance with the present invention integrates seamlessly within an object oriented programming framework that is modular and highly scalable. Thus, the object configuration tool facilitates customized configuration and implementation of objects through ordering of methods comprising those objects.

The developer can define the execution characteristics of the scenario by varying parameter values such as the number of iterations using the “Parameters” dialog box 42 shown in FIG. 3. The developer or user can also use a “Setup Method” check box 41 to specify that the method is a “setup” step, rather than a “test” step. Creating Web testing scenarios is quick and easy using the “Scenario Wizard” window 44, as shown in FIG. 6. The foregoing powerful features of the control center allow the developer or user to rapidly design workload scenarios that enable early detection of potential performance problems, task automation, monitoring, and system database maintenance.

The control center is for configuring tests and is also the control console for the developer or user. The test scenario is built in the “Scenario Wizard” window 44 that appears in the center of FIG. 6. The objects comprising the test scenario are fundamentally programs that are run by the control center, that is, they run through a service called “control”. Thus, the objects are input to the configuration for the controller, which runs the objects, like an application run on a computer.

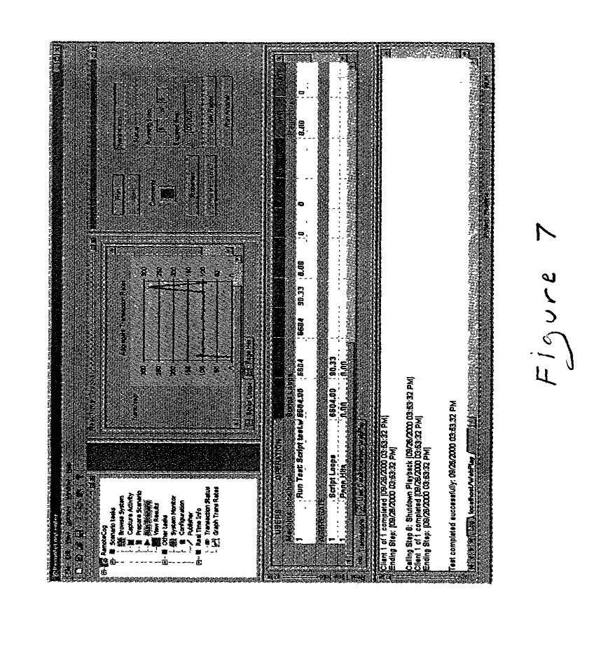

The control center preferably provides real time graphing, results, and user states enabling the developer or user to see what is occurring during a scenario execution, as shown in FIG. 7. Additionally, result data preferably populates the repository 14 shown in FIG. 1, which enables generation of sophisticated reports using a report generator of choice.

The object configuration tool in accordance with the present invention effectively aggregates methods within an object and provides the order in which the methods is carried out. Unlike known object oriented systems, the object configuration tool of the present invention enables modularized methods aggregated within an object to be ordered and/or re-ordered by the developer or user for configuring the object. The object configuration tool in accordance with the present invention thus enables objects to be easily and quickly configured so that testing and monitoring scenarios incorporating those objects can be created and/or modified by the developer or user for more rapid deployment in mission critical testing and monitoring scenarios for computer networks, for example, to address the uptime problem.

Although the present invention has been described with a particular degree of specificity with reference to a preferred embodiment, it should be understood that numerous changes both in the form and steps disclosed can be made without departing from the spirit of the invention. For example, the object configuration tool is not required to apply to all methods comprising an object. That is, not all methods are required to have an autopaste specification. In an alternative embodiment, an object may have a set of two or more methods of which only a subset can be autopasted, that is, only certain methods have an autopaste specification. Consequently, if the developer or user autopastes the object, only the methods that have an autopaste specification appear in the “Scenario Wizard” window 44. Additionally, if the developer or users were to autopaste the same object from different machines, the scenario wizard would automatically merge the two together (i.e., so that they are executed in parallel simultaneously). If autopaste is invoked such that two or more different objects are merged by the scenario wizard, it is preferable that all “setup” steps be executed before execution of “test” steps commences. The scope of protection sought is to be limited only by the scope of the appended claims that are intended to suitably cover the invention.

I claim:

1. A system to facilitate the arrangement of methods within an object built using an object oriented programming framework, the system comprising:
a plurality of methods comprising an object, each method consisting of a software module;
a control center comprising a graphical user interface to facilitate ordering the methods by a person who is one of a developer and a user;
an object workbench invoked by the person opening a code file, the object workbench displayed by the graphical user interface and comprising a window that contains a text list of the individual methods comprising the object;
a pointing device to select an individual method in the list;
a dialog box displayed by the graphical user interface when the individual method in the list is selected;
an editable field within the dialog box for entry by the person of a designation for the selected method corresponding to a desired place within a sequence in which the methods are to be performed; and
an intelligent mechanism whereby method software modules can self organize within the object, thereby permitting automation of the specification of the object;
whereby the system enables a developer or a relatively unsophisticated user to specify the order in which the methods are to be executed.

2. The system of claim 1 wherein the object is one of an object in an object library and a customized object coded by the developer.

3. The system of claim 1 wherein the pointing device is a mouse.

4. The system of claim 1 wherein the person enters a unique sequential integer ascending from the number “1” in the editable field to designate the place for the selected method within the sequence.

5. The system of claim 1 wherein the system integrates seamlessly within the object oriented programming framework that is modular and highly scalable.

6. The system of claim 1 wherein the system enables customized configuration and implementation of a plurality of objects through ordering of methods comprising the objects.

7. The system of claim 1 wherein the system is embedded within a computer network testing and monitoring tool to provide an automatic sequencing mechanism for self organizing of methods within the graphical user interface used to specify the methods.

8. The system of claim 1 wherein the system is embedded within a computer network testing and monitoring tool that provides distributed advanced protocol and technology independent capabilities that enable publishing, controlling, and running the object anywhere on the computer network or Internet.

9. The system of claim 8 wherein the object is a toolbox consisting of a member of the group of toolboxes comprising a) an eBusiness toolbox that enables rapid testing of Web sites by running a plurality of virtual Web users against a Web site and enables capture and play back of wireless browser traffic, b) an ODBC toolbox to construct scenarios that issue SQL against an ODBC compliant DBMS for database access, c) a Mail toolbox to stress and monitor SMTP and POP3 e-mail servers and to enable message size and e-mail addresses to be randomized for testing and to detect e-mail problems, d) an OS toolbox to construct scenarios that use UNIX or Windows command line utilities and which contains a “PING” (Preventative InterNet Guard) object that enables the person to monitor any machine and take action on failure, including paging or notifying a system administrator, and e) an FTP toolbox to enable fast testing of FTP servers and allow the person to specify message size, upload, and download information to test user experience at a Web site, including FTP downloads.

10. The system of claim 8, further comprising a repository to centrally store information and results.

11. The system of claim 10 wherein the repository resides in an ODBC compliant datastore.

12. The system of claim 1 wherein the control center further comprises an object browser to list the object and wherein the pointing device enables the person to select the entire object and to drag and drop the entire object into a scenario wizard window displayed by the graphical user interface, the methods comprising the object having the desired order designated using the editable field within the dialog box.

13. The system of claim 12 wherein each individual method comprising the dropped object appears as a respective icon in the scenario wizard window.

14. The system of claim 12 wherein the person enters a unique sequential integer ascending from the number “1” in the editable field and wherein method icons are automatically arranged from the top of the scenario wizard window towards the bottom of the scenario wizard window in the order previously designated using the editable field from the lowest number to the highest.

15. The system of claim 1, further comprising a second dialog box displayed by the graphical user interface when the individual method in the list is selected to specify at least one parameter for the method.

16. The system of claim 8 wherein the control center provides real time graphing, results, and user states enabling the person to observe what is occurring during object execution.

17. The system of claim 10, further comprising a report generator and wherein result data populates the repository and enables generation of reports using the report generator.

18. The system of claim 1 wherein the system enables customized configuration and implementation of the object.

19. A method to effectively re-order available methods within an object, the method comprising the steps of:
opening a code file corresponding to an object;
invoking an object workbench in response to opening the code file;
causing a window to appear in response to invoking the object workbench, the window displaying a text list of individual methods comprising the object;
providing a pointing device;
selecting an individual method in the list with the pointing device;
causing a dialog box to appear in response to selecting the method in the list;
providing an editable field within the dialog box;
entering a designation for the selected method in the editable field corresponding to a desired place in an order in which the selected method is to be performed; and
conforming the structured ordering of the code so that the method is performed at the designated place in the order;
thereby enabling modularized methods aggregated within an object to be ordered using a dialog box for configuring the object.

20. The method of claim 19, further comprising the step of modifying the code corresponding to at least one method.

21. The method of claim 19 wherein the pointing device is a mouse and double clicking the left mouse button with a mouse pointer on the selected method in the list causes the dialog box to appear.

22. The method of claim 19 wherein the designation is a unique sequential integer ascending from the number “1” entered in the editable field.

23. The method of claim 19 wherein the step of selecting an individual method is repeated for each method in the list.

24. The method of claim 19, further comprising the steps of:
selecting an entire object from an object browser with the pointing device;
dragging and dropping the selected object into a scenario wizard window; and
displaying the methods comprising the selected object in the scenario wizard window in the order designated by the corresponding entries in the editable field to specify the order of the methods.

25. The method of claim 24 wherein the pointing device is a mouse and wherein the step of selecting the entire object comprises dragging and dropping the entire object into the scenario wizard window.

26. The method of claim 25 wherein each individual method included in the dropped object appears as an icon in the scenario wizard window.

27. The method of claim 25 wherein the designation is a unique sequential integer ascending from the number “1” entered in the editable field and the methods are automatically arranged from the top of the scenario wizard window towards the bottom of the scenario wizard window in the order from the lowest number to the highest.

28. The method of claim 19, further comprising the step of specifying at least one parameter for the method using a second dialog box.

29. The method of claim 19 wherein there is a plurality of objects, and further comprising the steps of:
specifying a scenario by selecting at least one object to be run; and
automatically organizing the methods within the at least one object in the designated order in response to specifying a scenario;
thereby permitting automation of the ordering of methods contained in the at least one object within the specified scenario.

30. The method of claim 29 wherein objects are easily and quickly configured so that testing and monitoring scenarios incorporating the objects can be created and modified for rapid deployment as mission critical testing and monitoring scenarios for computer networks to address an uptime problem.
